(19) United States
(12) Patent Application Publication
(10) Pub. No.: US 2005/0230644 A1
(43) Pub. Date: Oct. 20, 2005

(54) Structure of far infrared radiator and projection head of the same

(76) Inventor: Li-Fa Tsai, Taipei (TW)

Correspondence Address: Yi-Wen Tseng, 4331 Battle Lane, Fairfax, VA, 22033, US

(21) Appl. No.: 10/823,753

(22) Filed: Apr. 14, 2004

(51) Int. Cl. H01K 7/00

(52) U.S. Cl. 250/504 R

(57) ABSTRACT

A structure improvement of a far infrared radiator and a projection head thereof is disclosed. A covering layer made of ceramic powders, high-temperature adhesive and water is coated on a frame wound with a high-resistant wiring (nickel-chromium wire). When a source power is supplied from the lamp base to generate infrared radiation containing visible range of light, the covering layer blocks the near infrared radiator carried by the infrared radiation, such that only the far infrared radiator with lower thermal energy can pass through to radiate the lampshade. The lampshade then reflects the far infrared radiator upon the skin of the patient. Therefore, during thermal treatment, the patient will not subjected to excessive heat and high temperature.

### BACKGROUND OF THE INVENTION

The present invention relates in general to a structure improvement of a far infrared radiator and a projection head thereof, and more particularly, to a far infrared radiator which radiates far infrared light with lower energy, such that the patient under thermal treatment will not feel the heat.

Far infrared light is decoupled from infrared light. The components of infrared light include near infrared light, mid infrared light and far infrared light. The far infrared light having longer wavelength and lower energy is most applicable to human bodies, animals and vegetables. Far infrared light is a type of electromagnetic wave, and the human body is an organic entity, which is also a radiator of far infrared. Therefore, the far infrared light has very sufficient warming effect to human body. In addition, the far infrared light can penetrate deep into the skin and the subcutaneous tissues of the human body. It thus accelerates blood circulation to maintain a certain body temperature. Therefore, the far infrared light has been broadly applied in medical treatment.

The far infrared light can be quickly absorbed by the human body, and the far infrared light deep inside the human body generates vibration of atoms and molecules and thermal reaction by resonance. Therefore, the temperature of the subcutaneous tissues is increased to cause vasodilatation and accelerate blood circulation. Thereby, congested blood such as bruise that disturbs metabolism can be removed. The tissue is revived, and the growth of enzyme is accelerated. The old material and cytotoxic accumulated in the human can be metabolized with water via the glands.

However, the near infrared light carried by the infrared light has a shorter wavelength, such that higher thermal energy is released thereby. The skin radiated by the near infrared light for a long time will be burned thereby. Further, the crystal of eyes will be deformed or damaged by radiation of near infrared light. In the conventional medical equipment providing infrared treatment, the near infrared light has not been effectively filtered or blocked. Therefore, it is inevitable to harm the patient due to the high thermal energy.

### SUMMARY OF THE INVENTION

To resolve the drawbacks of the conventional design, a covering layer is coated on a projection head of an infrared radiator, such that the near infrared light with higher energy is blocked, while only the far infrared light with lower energy passes through. Therefore, the patient under treatment only feels a warm temperature. Application of the fomentation for a long period of time will not burn the skin or cause deformation of crystals of eyes of the patient.

The covering layer is mixed by ceramic powders, high-temperature adhesive and water to cover a high-resistant wiring (nickel/chromium). When the projection head is conducted to a source power to generate a visible infrared light beam, the near infrared light that has a higher energy is blocked by the covering layer. Therefore, the patient under thermal treatment will not feel excessive heat.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF ACCOMPANIED DRAWINGS

The above objects and advantages of the present invention will be become more apparent by describing in detail exemplary embodiments thereof with reference to the attached drawings in which:

FIG. 1 shows a perspective view of a projection head of an infrared radiator;

FIG. 2 shows the projection head coated with a covering layer;

FIG. 3 is a cross sectional view FIG. 2;

FIG. 4 is an exploded view of a projection head, a lamp base and a lampshade;

FIG. 5 shows the assembly of the projection head, the lamp base and the lampshade;

FIG. 6 is a cross sectional view FIG. 5; and

FIG. 7 shows another embodiment of an infrared radiator.

### DETAILED DESCRIPTION OF EMBODIMENT

Reference will now be made in detail to the preferred embodiments of the present invention, examples of which are illustrated in the accompanying drawings. Wherever possible, the same reference numbers are used in the drawings and the description to refer to the same or like parts.

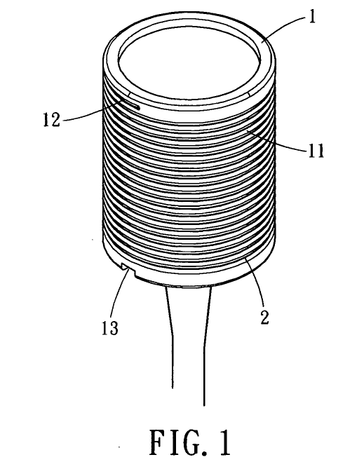

FIG. 1 illustrates a perspective view of a projection head of an infrared radiator. As shown, the projection head includes a frame 1, a high-resistant wiring 2 winding around the head frame 1, and a covering layer 3 coated on the frame 1 so as to wrap the high-resistant wiring 2 therein. When the high-resistant wiring 2 is conducted to a source power, an infrared beam containing visible components of light is generated. The covering layer 3 blocks the near infrared portion of the infrared light and only allows the far infrared portion of the infrared light to pass. Therefore, the near infrared light with higher energy will not be incident on the human body. The injury caused by high-energy near infrared light is thus prevented.

The frame 1 is fabricated from ceramic material, for example. The frame 1 is hollow and comprises a continuous grooves 11 formed along an exterior surface thereof to receive the high-resistant wiring 2 therein. Two openings 12 extending through the frame 1 are formed at two opposing ends of the groove 11, such that two ends of the high-resistant wiring 2 can be inserted inside of the frame 1. To dispose the frame 1 on a lamp base (not shown), the bottom edge of the frame 1 includes a recessed portion 13 to be engaged with connection structure of the lamp base.

The high-resistant wiring 2 is preferably fabricated from nickel-chromium (Ni—Cr) material, for example. The high-resistant wiring 2 is embedded in the groove 11 to wind about the frame 1. The ends of the high-resistant wiring 2 are inserted into the frame 1 through the openings 12. The ends of the high-resistant wiring 2 may further extend to connect a power supply through the lamp base. Thereby, an infrared radiation containing visible light can be generated.

The covering layer 3 is coated on a surface of the above frame 1 to cover the high-resistant wiring 2 therein. The covering layer 3 is fabricated from a mixture of ceramic powders, high-temperature adhesive, and water, for example. The covering layer 3 is operative to block the near infrared light contained in the infrared radiation generated by the high-resistant wiring 2, such that only the far infrared light with lower energy will emanate through the covering layer 3 to serve as the medical radiation source.

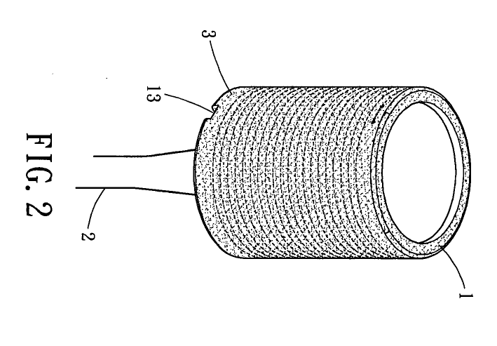

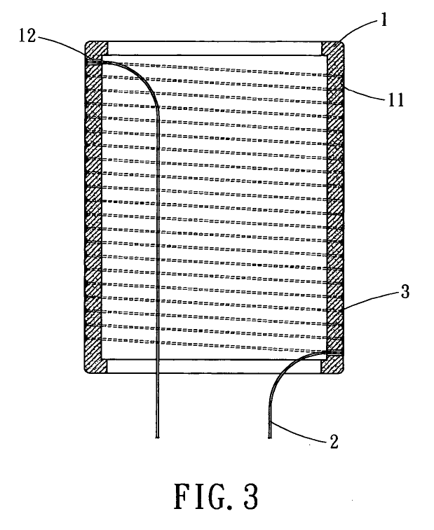

Referring to FIGS. 2 and 3, a perspective view and a cross-sectional view of a projection head coated with the covering layer are illustrated. After the high-resistant wiring 2 is conducted, an infrared radiation containing visible light is generated. The infrared radiation also includes near infrared light, mid infrared light and far infrared light.

As the near infrared light has a shorter wavelength, large amount of heat is generated thereby. Therefore, the skin or crystals of the patient under the radiation of the near infrared light for a significant period of time will be easily injured. On the contrary, the far infrared light has a longer wavelength, such that the energy is lower. Therefore, the skin will not be injured after a long period of radiation of far infrared light. Further, the far infrared radiation is advantageous in blood circulation, metabolism, and balance of PH value for the human body.

The covering layer 3 wrapping the high-resistant wiring 2 therein effectively blocks the near infrared light with higher energy. Therefore, even when the infrared radiation directly radiates on the skin or eyes of a patient for a period of time, the skins or crystals of the patient will not be injured by such radiation.

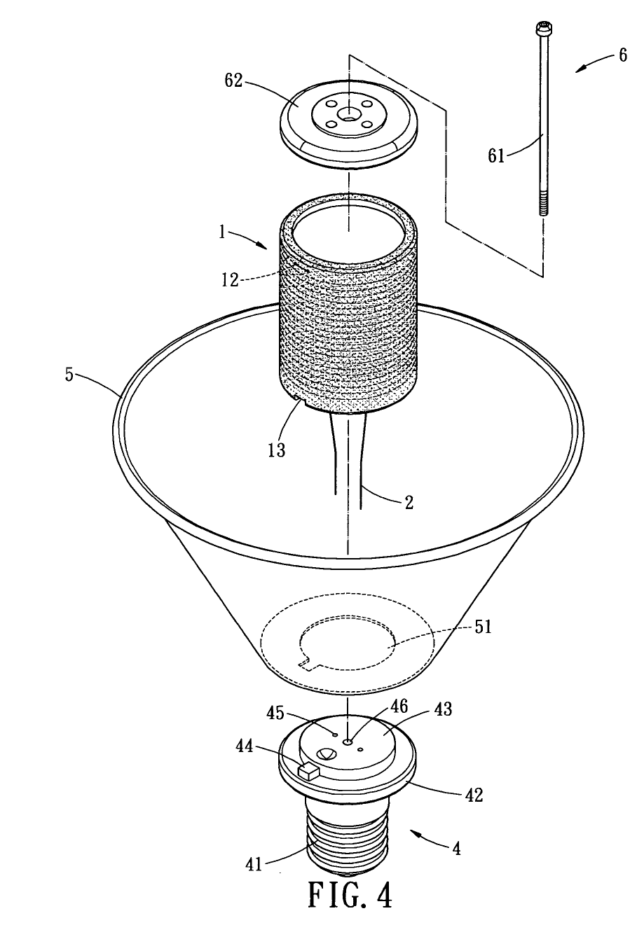

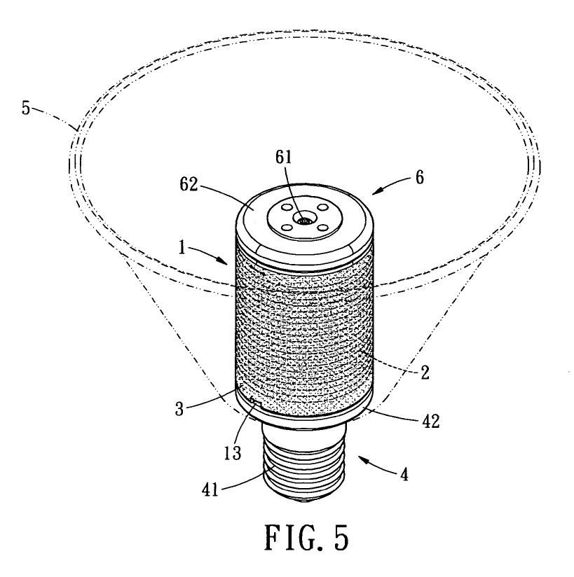

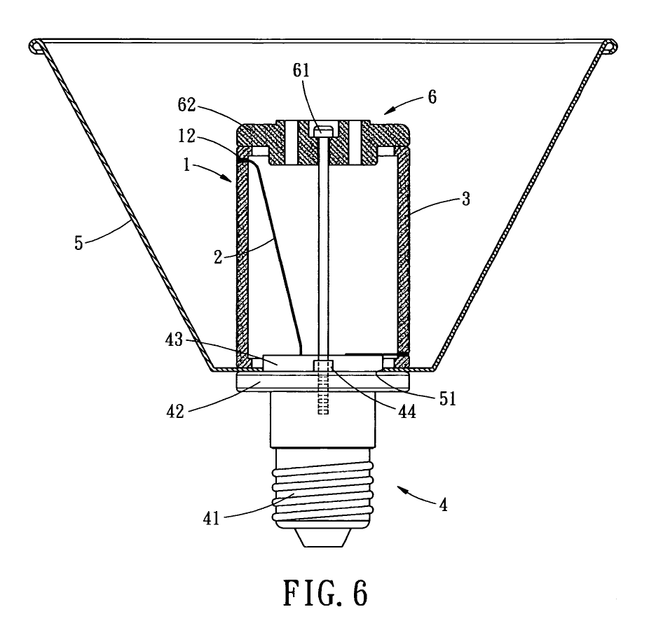

FIGS. 4-6 illustrate the projection head, the lamp base 4, and the lampshade 5. In this embodiment, the projection head, the lamp base 4 and the lampshade 5 are assembled by fasteners 6 to form a table lamp. The lamp base 4 includes a conducting terminal 41 connected to a stair-like connector 42 fabricated from ceramic material. The connector 42 is preferably in the form of a circular dish, while a smaller circular dish 43 is formed on the connector member 42 to serve as a connection member. The smaller circular dish 43 comprises a positioning member 44 protruding from a port of a periphery of thereof. As shown, the bottom of the lampshade 5 has an opening 51 conformal to a profile of the smaller circular dish 43, such that the lampshade 5 is disposed on the connector 42 by engaging the smaller circular dish 43 within the opening 51. As mentioned above, the bottom edge of the frame 1 has a recessed portion 13. By fitting the positioning member 44 within the recessed portion 13, the lampshade 5 is properly assembled with the projection head. The high-resistant wiring 2 extending out of the frame 1 is inserted into the socket 45 formed on the smaller circular dish 43. A fastening member 6 is then used to fasten the projection head with the lamp base 4. As shown, the fastening member 6 includes a cap 62 to be placed on a top edge of the frame 1 and a screw member 61. The cap 62 has an opening aligned with an opening 46 formed in the small circular dish 43. The screw member 61 is threaded through the opening of the cap 62 and the opening 46 of the smaller circular dish 43.

After assembly as mentioned above, the conducting terminal 41 of the lamp base 4 may transmits a power to the high-resistant wiring 2, such that a far infrared radiation is generated and radiating on the lampshade 5. The far infrared radiation is then reflected from the lampshade 5 to the human body to achieve medical treatment. During the treatment, the patient will not feel high temperature or excessive heat. The injury of skin or crystals of eyes caused by excessive amount of heat is prevented.

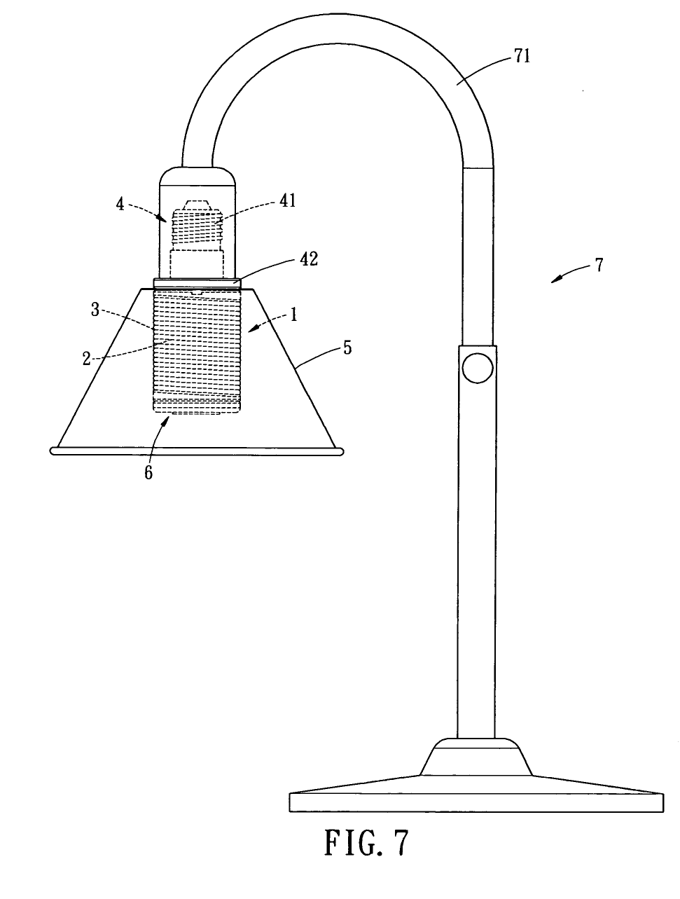

Referring to FIG. 7, another embodiment of the assembly of a projection head, a lamp base 4, a lampshade 5 and a fastening member 6 is illustrated. As shown, a lamp post 71 is used to form a floor lamp instead of a table lamp.

While the present invention has been particularly shown and described with reference to preferred embodiments thereof, it will be understood by those of ordinary skill in the art the various changes in form and details may be made therein without departing from the spirit and scope of the present invention as defined by the appended claims.

1. A projection head of a far infrared radiator, comprising:
a frame, comprising a groove formed along an exterior surface thereof and a pair of opening extending through the frame at two ends of the groove;
a high-resistant wiring embedded in the groove to wind about the frame, the high-resistant wiring being operative to generate infrared radiation; and
a covering layer wrapping the high-resistant wiring therein, the covering layer being operative to block near infrared light contained in the infrared radiation.

2. The projection head as claimed in claim 1, wherein the groove comprises a continuous groove extending between a bottom edge and a top edge of the frame.

3. The projection head as claimed in claim 2, wherein the groove extending along a spiral path.

4. The projection head as claimed in claim 1, wherein frame includes a recessed portion at a bottom edge thereof.

5. The projection head as claimed in claim 1, wherein the high-resistant wiring is fabricated from nickel-chromium material.

6. The projection head as claimed in claim 1, wherein the covering layer is fabricated from a mixture of ceramic powder, high-temperature adhesive and water.

7. An infrared radiator, comprising:
a lamp base, comprising a conductive terminal and a connector on the conductive terminal;
a lamp shade disposed on the connector;
a projection head, in electric communication with the conductive terminal of lamp base and connected to the connector, wherein the projection head further comprising:
an infrared radiation generator; and
a covering layer covering the infrared radiation generator therein, wherein the covering layer is operative to block a high-energy portion of the infrared radiation generated by the infrared radiation generator; and
a fastening members to fasten the lamp projection head with the lamp base.

8. The radiator as Claim in claim 7, wherein the connector is fabricated from ceramic material.

9. The radiator as claimed in claim 7, wherein the connector comprising at least one socket in electric communication with the conductive terminal.

10. The radiator as claimed in claim 9, wherein the infrared radiation generator extends out of the projection head to be plugged into the socket.

11. The radiator as claimed in claim 7, wherein the infrared radiation generator includes a high-resistant wiring.

12. The radiator as claimed in claim 11, wherein the covering layer is fabricated from a mixture of ceramic powders, high-temperature adhesive and water.
